(19) United States
(12) Patent Application Publication
(10) Pub. No.: US 2004/0043667 A1
(43) Pub. Date: Mar. 4, 2004

(54) Connector structure for rope light

(76) Inventor: Hsien-Te Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,856

(22) Filed: Aug. 27, 2002

(51) Int. Cl. H01R 24/00

(52) U.S. Cl. 439/662

(57) ABSTRACT

A rope light connector releasably connects a first rope light and a second rope light together, each of the rope light having a first wire and a second wire extending therethrough. The rope light connector includes a male member and a female member integrally and respectively mounted to the first and second rope lights. The male member forms a plug having an external threaded section. The female member defines a receptacle to selectively receive the plug. The receptacle has inner threaded section engageable with the external threaded section of the plug to releasably secure the female member to the male member. Conductive members are formed in the plug and the receptacle to form engagement between the wires of the rope lights.

### BACKGROUND OF THE INVENTION

1. Field of the Invention

The present invention relates generally to a rope light connector, and in particular to a rope light connector having a simplified structure.

2. The Related Art

Rope lights that comprise an elongate, light-transmitting tube inside which a number of bulbs are fixed are known. An example is disclosed in U.S. Pat. No. 6,379,190. In most applications, it needs to connect a number of rope lights together. Such a connection is done by means of a rope light connector. The above US patent teaches a rope light connector having a receptacle member formed at an end of a first rope light and a plug formed at a corresponding end of a second rope light. To connect the first and second rope lights, the plug is inserted into the receptacle. The plug forms an external threading. The first rope light comprises a sleeve locker movable along and rotatable about the first rope light. The sleeve locker forms an inner threading engageable with the external threading of the plug thereby securing the second rope light to the first rope light.

The conventional rope light connector, although effective to connect two rope lights, requires an inner-threaded sleeve locker that is not an integral part of the rope light. When the sleeve locker slides along, it also rubs against the surface of the connector and therefore causes damage to the connector. Moreover, the gap between the sleeve locker and the connector enables water leakage in the connector. Further, such an additional sleeve locker increases the production cost of the rope lights.

In addition, the rope lights are always used outdoors. The conventional rope light disclosed in the above US patent is not waterproof, and cannot resist water leakage through connector. Subsequently, electric shorting may occur, and users may be damaged or fire may be caused.

Thus, it is desired to have a rope light connector that can overcomes the problems discussed above.

### SUMMARY OF THE INVENTION

An object of the present invention is to provide a rope light connector having a simple structure that can simplify the production process and reduce cost.

Another object of the present invention is to provide a rope light connector having no free fastening part.

A further object of the present invention is to provide a rope light connector that provides a waterproof sealing against water leakage.

To achieve the above objects, in accordance with the present invention, there is provided a rope light connector for releasably connecting a first rope light and a second rope light together. The rope lights have a first wire and a second wire extending therethrough. The rope light connector comprises a male member and a female member integrally and respectively mounted to the first and second rope lights. The male member forms a plug having an external threaded section. The female member defines a receptacle to selectively receive the plug. The receptacle has inner threaded section engageable with the external threaded section of the plug to releasably secure the female member to the male member. Both the plug and the receptacle include conductive members to selectively form engagement between the wires of the rope lights.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a rope light connector constructed in accordance with a first embodiment of the present invention;

FIG. 2 is a perspective view of the rope light connector of the first embodiment of the present invention;

FIG. 3 is an exploded and axial sectional view taken along line 3-3 of FIG. 1;

FIG. 4 is a perspective and axial sectional view taken along line 4-4 of FIG. 2;

FIG. 5 is an exploded view of a rope light connector constructed in accordance with a second embodiment of the present invention;

FIG. 6 is a perspective view of the rope light connector of the second embodiment of the present invention;

FIG. 7 is a exploded and axial sectional view taken along line 7-7 of FIG. 5; and

FIG. 8 is a perspective and axial sectional view taken along line 8-8 of FIG. 6.

### DETAILED DESCRIPTION OF THE PREFERRED EMBODIMENTS

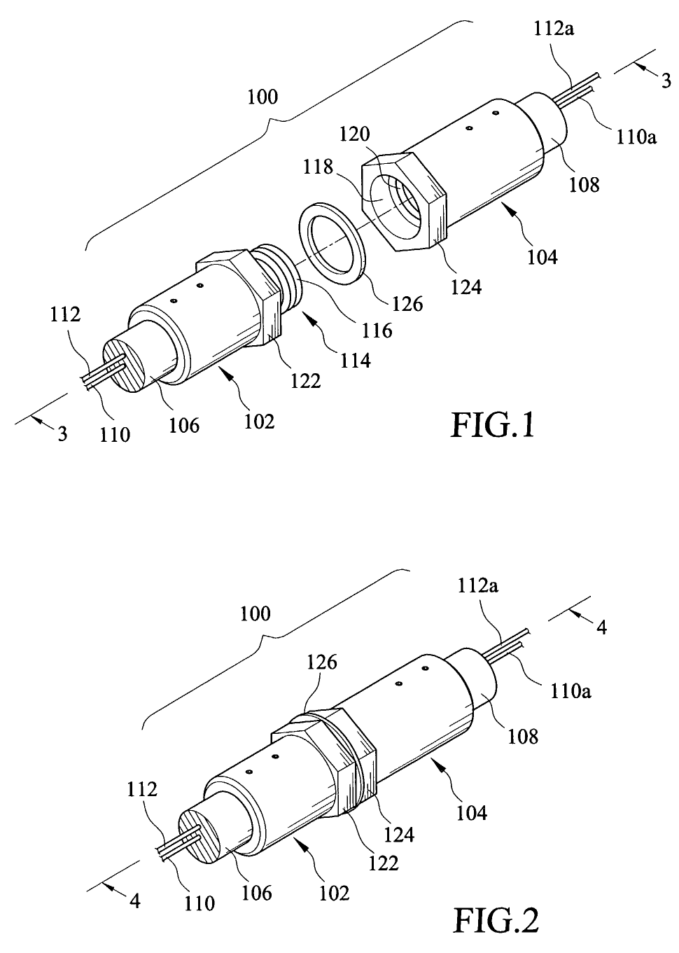

With reference to the drawings and in particular to FIGS. 1 to 2, a rope light connector constructed in accordance with a first embodiment of the present invention, generally designated with reference numeral 100, comprises a male member 102 and a female member 104 to which a first rope light 106 and a second rope light 108 are respectively and integrally mounted. A conductive central wire 110 and a side wire 112 extend parallelly through the first rope light 106 and are spaced from each other. Similarly, a central wire 110a and a side wire 112a extend parallelly through the second rope light 108 and are spaced from each other. Both the central wires 110, 110a and side wires 112, 112a function for supplying electric power to the rope lights.

The male member 102 has an integral plug 114 around which is formed with external threaded section 116. The female member 104 has a receptacle 118 with an inner threaded section 120. The receptacle 118 is slightly larger than the plug 114 of the male member 102 so that the plug 114 can be received therein. The inner threaded section 120 of the female member 104 can be screwed and engaged with the external threaded section 116 of male member 102, thereby securing the male and female members 102, 104 together.

The male member 102 and the female member 104 both form a polygonal ring section 122, 124 which in the embodiment illustrated is hexagonal. It is designed for driving engagement with for example a wrench to tighten the male and female members 102, 104 together. The polygonal ring sections 122, 124 have an inner cross-sectional size greater than that of the plug 114 of the male member 102. To prevent water leakage, a sealing ring 126 made of plastics is used and sandwiched between the polygonal ring sections 122, 124 when the male and female members 102, 104 are secured together. The elasticity of the sealing ring 126 enables the two corresponding sides of the sealing ring 126 to respectively tightly contact with the polygonal ring sections 122, 124, and no water can leak into the rope light connector 100 and the rope lights 106, 108. In other words, the sealing ring 126 provides a waterproof sealing between the male and female members 102, 104.

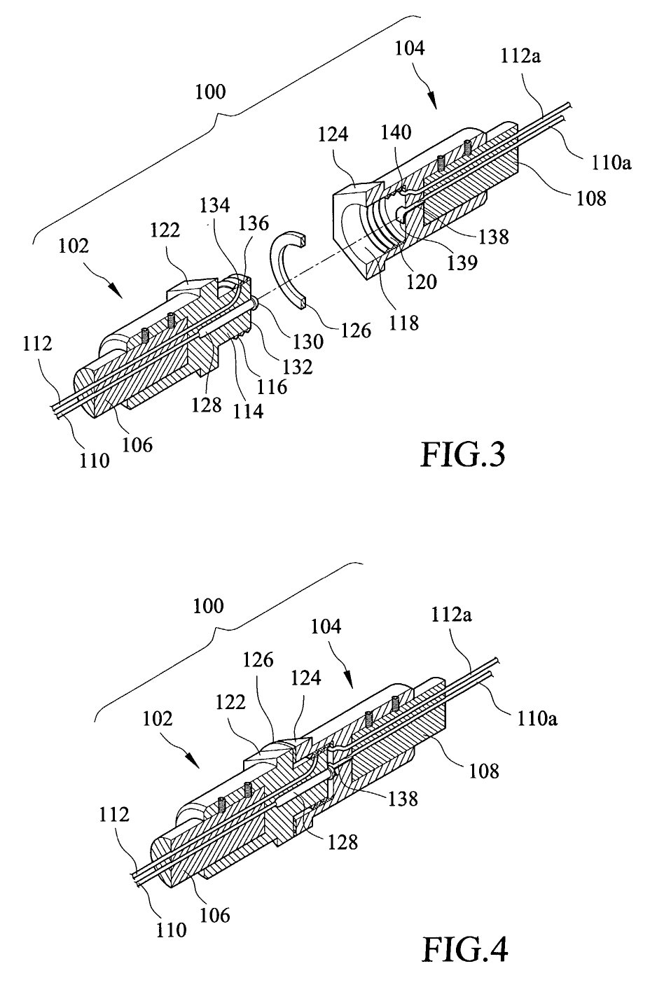

Please refer to FIG. 3 which is an exploded and axial sectional view taken along line 3-3 of FIG. 1. An expanded portion 128 with a free end section 130 is extended from the central wire 110 of the first rope light 106 to the male member 102. The free end section 130 is protruded from an axial end face 132 of the plug 114 of the male member 102. The side wire 112 of the first rope light 106 is extended to the male member 102, and is formed with a free end 134 extending beyond the external threaded section 116 of the plug 114. The free end 134 is physically engaged with a conductive member 136, which in the embodiment illustrated constitutes partly the plug 114 of the male member 102. Alternatively, the external threaded section 116 may be made of conductive material, so that the free end 134 of the side wire 112 of the male member 102 is connected with the conductive external threaded section 116.

A flat contact portion 138 with a bent expanded end 139 is extended from the central wire 110a of the second rope light 108 to the female member 104. The bent expanded end 139 of the central wire 110a is positioned in corresponding to the free end section 130 of the central wire 110. As shown in FIG. 4 which is a perspective and axial sectional view taken along line 4-4 of FIG. 2, when the male and female members 102, 104 are secured together, the bent expanded end 139 is engaged with the free end section 130. Moreover, the side wire 112a of the female member 104 comprises a free end 140 extending into the receptacle. When the male member 102 is screwed to the female member 104, the free end 140 is physically engaged with the conductive member 136 of the male member 102. Thereby, the two rope lights are electrically connected.

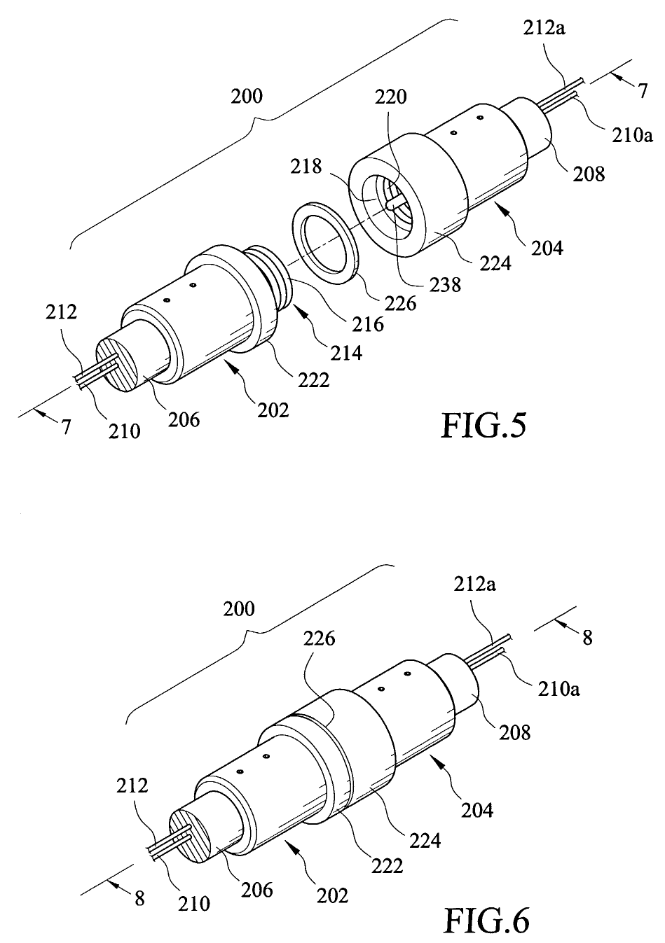

FIGS. 5 and 6 show a rope light connector constructed in accordance with a second embodiment of the present invention, generally designated with reference numeral 200. The rope light connector comprises a male member 202 and a female member 204 to which a first rope light and a second rope lights 206, 208 are respectively mounted. A conductive central wire 210 and a side wire 212 extend parallelly through the first rope light 206 and are spaced from each other. Similarly, a central wire 210a and a side wire 212a extend parallelly through the second rope light 208 and are spaced from each other. Both the central wires 210, 210a and side wires 212, 212a function for supplying electric power to the rope lights.

The male member 202 has a plug 214 around which is formed with external threaded section 216. The female member 204 has a receptacle 118 with an inner threaded section 220. The receptacle 218 is slightly larger than the plug 214 of the male member 202 so that the plug 214 can be received therein. The inner threaded section 220 of the female member 204 can be screwed and engaged with the external threaded section 216 of male member 202, thereby securing the male and female members 202, 204 together.

The male member 202 and the female member 204 both form an expanded ring section 222, 224. The expanded ring sections 122, 124 have an inner cross-sectional size greater than that of the plug 214 of the male member 202. To prevent water leakage, a sealing ring 226 made of plastics is used and sandwiched between the expanded ring sections 222, 224 when the male and female members 202, 204 are secured together. The elasticity of the sealing ring 126 enables the two corresponding sides of the sealing ring 226 to respectively tightly contact with the expanded ring sections 222, 224, and no water can leak into the rope light connector 200 and the rope lights 206, 208. In other words, the sealing ring 226 provides a waterproof sealing between the male and female members 202, 204.

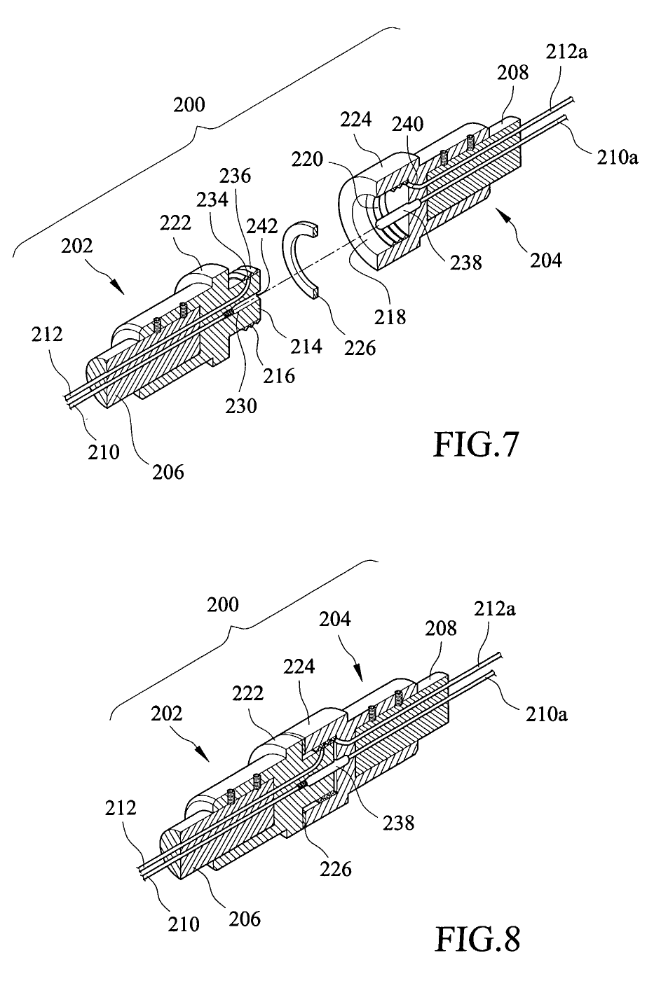

Please refer to FIG. 7 which is an exploded and axial sectional view taken along line 7-7 of FIG. 5. The central wire 210 of the male member 202 has a free end section 230 extending into an axially extending bore 242 defined in the plug 214 of the male member 202.

The side wire 212 of the first rope light 206 is extended to the male member 202, and is formed with a free end 234 extending beyond the external threaded section 216 of the plug 214. The free end 234 is physically engaged with a conductive member 236, which in the embodiment illustrated constitutes partly the plug 214 of the male member 202. Alternatively, the external threaded section 216 may be made of conductive material, so that the free end 234 of the side wire 212 of the male member 202 is connected with the conductive external threaded section 216.

As shown in FIG. 8 which is a perspective and axial sectional view taken along line 8-8 of FIG. 6, the central wire 210a of the female member 204 has a free end forming a plunger 238 extending into the receptacle 218 for insertion into the bore 242 to physically engage the free end section 230 of the central wire 210 of the male member 202. Moreover, the side wire 212a of the female member 204 has a free end 240 extending into the receptacle 218. When the male member 202 is screwed to the female member 204, the free end 240 is physically engaged with the conductive member 236 of the male member 202. Thereby, the two rope lights are electrically connected.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A rope light connector for releasably connecting a first rope light and a second rope light, each having a first wire and a second wire extending therethrough, the rope light connector comprising:
a male member adapted to be integrally mounted to an end of the first rope light, which comprises a plug having an external threaded section;
a female member adapted to be integrally mounted to an end of the second rope light, which comprises a receptacle selectively receiving the plug, the receptacle having inner threaded section engageable with the external threaded section of the plug thereby securing the female member to the male member; and
two conductive members respectively formed in the plug and the receptacle to form engagement between the wires of the rope lights.

2. The rope light as claimed in claim 1, wherein the male and female members respectively form an expanded ring section.

3. The rope light as claimed in claim 2, wherein the expanded ring section is configured to be polygonal.

4. The rope light as claimed in claim 2 further comprising a sealing ring sandwiched between the expanded ring sections.

5. The rope light as claimed in claim 1, wherein the conductive member in the plug comprise a first conductor connected to the first wire of the first rope light and having a free end extending beyond the plug and an end portion of the second wire of the first rope light extending beyond the plug and physically engaging a second conductor, and wherein the conductive members in the receptacle comprise a third conductor connected to the first wire of the second rope light and forming a bent expanded end for engaging the free end of the first conductor and an end portion of the second wire extending into the receptacle for engaging the second conductor.

6. The rope light as claimed in claim 1, wherein the conductive members in the plug comprise an end portion of the first wire of the first rope light embedded in a bore defined in the plug and an end portion of the second wire of the first rope light extending beyond the plug and physically engaging a second conductor, and wherein the conductive members in the receptacle comprise a conductive plunger connected to the first wire of the second rope light and extending into the receptacle for insertion into the bore to engage the end portion of the first wire of the first rope light and an end portion of the second wire extending into the receptacle for engaging the second conductor.
